(19) United States
(12) Patent Application Publication
(10) Pub. No.: US 2023/0196605 A1
(43) Pub. Date: Jun. 22, 2023

(54) MEASUREMENT APPARATUS, STORAGE MEDIUM, SYSTEM AND METHOD OF MANUFACTURING ARTICLE

(71) Applicant: CANON KABUSHIKI KAISHA, Tokyo (JP)

(72) Inventor: Takayuki UOZUMI, Tochigi (JP)

(21) Appl. No.: 18/061,155

(22) Filed: Dec. 2, 2022

(30) Foreign Application Priority Data
Dec. 22, 2021 (JP) 2021-208219

(51) Int. Cl. G06T 7/70; G06T 7/55; G06V 10/75; G01N 21/84

(52) U.S. Cl. CPC G06T 7/70; G06T 7/55; G06V 10/751; G01N 21/84; G01N 2021/8455

(57) ABSTRACT

To provide a measurement apparatus and the like that suppresses an error caused by an image used for measurement, and that enables measurement with a high accuracy, in a measurement apparatus, a measurement unit is configured to calculate a measurement value with respect to a measurement target by using a cross-correlation function of two images of the measurement target acquired by an image capturing element, and a correction unit is configured to correct the measurement value according to a configuration of a spatial frequency component of the two images.

### BACKGROUND OF THE INVENTION

### Field of the Invention

The present invention relates to a measurement apparatus, a storage medium, a system, and a method of manufacturing an article and the like.

### Description of the Related Art

As a conventional non-contact measurement apparatus, there is a measurement apparatus disclosed in Japanese Examined Patent Application Publication No. 59-52963. This measurement apparatus generates speckles by irradiating a measurement target with a laser, obtains two image capturing signals by photoelectrically converting speckle distribution before and after motion, and calculates the deformation amount of the measurement target based on the position of the extreme value of the correlation function of the two signals. In Japanese Examined Patent Application Publication No. 59-52963, the measurement is performed by using speckles, but a similar measurement can be performed even with normal image information by using incoherent illumination.

In Japanese Patent Laid-Open No. 2003-222504, an optical magnification is determined in accordance with a measured displacement amount in order to achieve high accuracy in a displacement measurement apparatus.

Japanese Patent Laid-Open No. 2003-222504 discloses a method for correcting distortion caused by a light-receiving optical system of a displacement measurement apparatus. In a light-receiving optical system having a large distortion, the influence of the distortion is different depending on the displacement amount. In a case in which the displacement amount is small, the optical magnification is equal to the design value, but in a state in which the displacement amount becomes large, the deviation between the optical magnification and the design value becomes large. Thus, by measuring the distortion amount of the optical system in advance, by measuring the distortion amount of the optical system in advance, the optical magnification is corrected in accordance with the displacement amount.

However, errors that occur in a displacement measurement apparatus are not limited to those caused by an optical magnification such as distortion, and in the method of correcting optical magnification as disclosed in Japanese Patent Laid-Open No. 2003-222504, there was a problem in that errors other than these cannot be sufficiently corrected.

Accordingly, it is one object of the present invention to provide a measurement apparatus and the like that suppresses an error caused by an image that is used for measurement, and that enables measurement with a high accuracy.

### SUMMARY OF THE INVENTION

In order to achieve the above object, a measurement apparatus according to one aspect of the present invention is configured to include a circuit configured to function as a measurement unit that is configured to calculate a measurement value with respect to a measurement target by using a cross-correlation function of two images of the measurement target acquired by an image capturing element, and a correction unit that is configured to correct the measurement value according to a configuration of a spatial frequency component of the two images

Further features of the present invention will become apparent from the following description of embodiments with reference to the attached drawings.

### BRIEF DESCRIPTION OF THE DRAWINGS

FIG. 1 is a block diagram showing an example of a length-measuring instrument as the measurement apparatus of a first embodiment.

FIG. 2 is a flowchart showing an example of a measurement flow of a length-measuring instrument of a first embodiment.

FIG. 3 is a flowchart showing a specific example of a displacement amount computation in step S14 of FIG. 2.

FIG. 4A is a diagram showing a surface dependency of length measurement error data in a case in which a metal sample and a paper sample are measured as a measurement target 2. FIG. 4B is a diagram showing line sensor output data of a metal sample and a paper sample.

FIG. 5A is a diagram showing the WD dependency of the length measurement error data in a case in which a metal sample is measured as the measurement target 2. FIG. 5B is a diagram showing line sensor output data in a case in which the WD is at the center and in a case in which the WD is at an end portion.

FIG. 6A is a diagram showing the speed dependency of the length measurement error data of the measurement target 2. FIG. 6B is a diagram showing line sensor output data in a case in which the speed of the measurement target 2 is different.

FIG. 7 is a schematic diagram for explaining the occurrence of a sub-pixel estimation error.

FIG. 8A is a diagram showing a cross-correlation function in a case in which a high-frequency component is dominant as a configuration of a spatial frequency component included in a line sensor output. FIG. 8B is a diagram showing a cross-correlation function in a case in which a low-frequency component is dominant as a configuration of a spatial frequency component included in a line sensor output.

FIG. 9 is a graph that plots the relationship between the spread of the peak shape of the cross-correlation function and the length measurement error based on the result of performing a length measurement under various measurement conditions.

FIG. 10 is a schematic diagram for explaining a quadratic function fitting that is used in a sub-pixel estimation computation.

FIG. 11A is a diagram showing a length measurement error in a case in which correction is not is performed under various conditions, and FIG. 11B is a diagram showing a correction effect of the first embodiment, wherein FIG. 11B is a diagram showing a length measurement error in a case in which the correction is executed under the same condition.

FIG. 12 is a diagram explaining an example of using a linear function fitting as a method of calculating the sub-pixel estimation of the cross-correlation function and the spread of the peak shape.

FIG. 13 is a diagram showing a control system configured to include a measurement apparatus and a robot arm in a third embodiment.

### DESCRIPTION OF THE EMBODIMENTS

Hereinafter, with reference to the accompanying drawings, favorable modes of the present invention will be described using embodiments. In each diagram, the same reference signs are applied to the same members or elements, and duplicate descriptions will be omitted or simplified.

### First Embodiment

The present inventor has found a tendency that a measurement error becomes large in a case in which a low-frequency component is dominant as a configuration of a spatial frequency component included in an image to be used. For example, in the measurement of a measurement target having a significantly varying surface roughness, the measurement error becomes large when the low-frequency component becomes dominant as a configuration of the spatial frequency component of the measurement target surface pattern.

Further, for example, in a case in which the distance to the measurement target changes and a shake occurs in the image, or in a case in which a blur occurs in an image because the exposure time is constant and the speed of the measurement target becomes faster, the measurement error similarly becomes large. That is, the measurement error becomes large in a case in which the ratio of the frequency component that is lower than a predetermined frequency in the distribution of the spatial frequency component of the image of the measurement target is equal to or greater than a predetermined ratio. Therefore, it has been found that in such a case, it is desirable to correct the measurement value.

Accordingly, the measurement apparatus 1 of the first embodiment is configured so that the measurement error is corrected according to the configuration of the spatial frequency component.

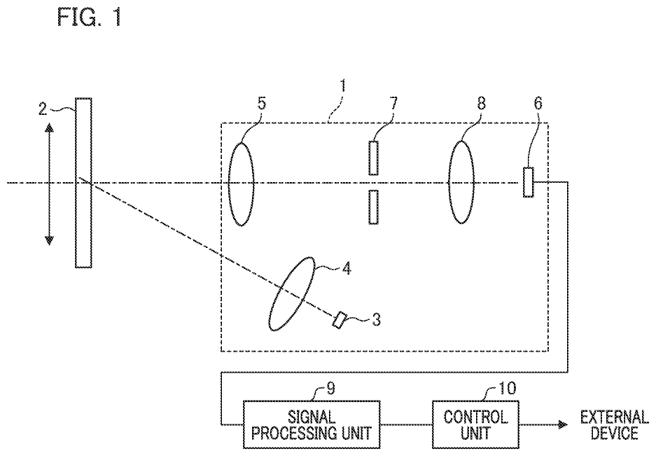

FIG. 1 is a block diagram showing an example of a length-measuring instrument as the measurement apparatus 1 (displacement measurement apparatus) of the first embodiment. The measurement apparatus 1 of the first embodiment is configured to measure the displacement of a measurement target 2 that is disposed opposite to the measurement apparatus 1 in a non-contact manner. The measurement target 2 moves in the direction of the arrows.

The light flux emitted from a light source 3 is condensed on the measurement target 2 by a light condensing member 4, and illuminates the measurement target 2.

The light source 3 can be appropriately selected from a laser diode, an LED, a halogen lamp, or the like. An image obtained in a case in which a laser diode is selected is an image configured by speckles, and in a case in which an incoherent light source such as an LED or halogen lamp is selected, an image reflecting the pattern of the surface of the measurement target 2 is obtained.

The light condensing member 4 is configured by a single lens or a lens group. In a case in which a laser diode is used, it is desirable to perform aberration correction so that light can be condensed by a plane wave. In addition, in a case in which the distance between the measurement apparatus 1 and the measurement target 2 changes, it is desirable to configure coaxial epi-illumination because displacement of the speckle occurs in oblique incidence illumination.

In contrast, in a case in which an incoherent light source such as an LED or halogen lamp is selected, it is sufficient that the light receiving region can be illuminated, and because aberration and the like are not particularly problematic, it can be appropriately selected according to the size of the region to be illuminated.

A part of the light flux that is diffusely reflected from the illuminated measurement target 2 is condensed on, for example, a sensor 6 serving as an image capturing element via a light receiving optical system that is configured by a light condensing member 5, an aperture diaphragm 7, and a light condensing member 8. In the first embodiment, a double-sided telecentric optical system is adopted as the light-receiving optical system.

The light condensing members 5 and 8 are arranged so that their focal points correspond with each other, and the aperture diaphragm 7 is disposed at that position. By adopting a double-sided telecentric optical system, the configuration becomes one in which the magnification of the optical system does not easily change even if the distance between the measurement apparatus 1 and the measurement target 2 changes, and it is possible to implement a configuration that is less susceptible to effects such as positional deviation due to a change in the installation environment temperature.

Hereinafter, the distance between the attachment reference surface of the measurement apparatus 1 and the measurement target 2 is referred to as “WD” (Working Distance). The light condensing members 5 and 8 are configured by a single lens or a group of lenses. The magnification of the optical system is determined by the ratio of the focal lengths of the light condensing members 5 and 8.

A desired resolution can be selected as appropriate. In a case in which the change of the WD and the change in the installation position of the sensor 6 is negligible, an ordinary image forming optical system may be selected. Further, in a case in which a change in the WD is not negligible, but a change in the installation position of the sensor 6 is negligible, it is possible to select an object-side telecentric optical system.

The sensor 6 is configured by a photoelectric conversion element array such as a CCD element or a CMOS element. The sensor 6 is a line sensor or an area sensor, and in a case of an area sensor, it is possible to detect a two-dimensional displacement, and in a case in which a line sensor is selected, it is possible to detect a one-dimensional displacement. Here, a one-dimensional length measurement (displacement amount) by using a line sensor will be explained. However, the measurement in the first embodiment is not limited to a length measurement (displacement amount).

After the light flux that was formed on the sensor 6 has been photoelectrically converted, the light flux is output to the signal processing unit 9 and processed for dynamic range correction and gamma correction and the like to generate image data (data for each image). The image data that is generated by the signal processing unit 9 is supplied to a control unit 10. The control unit 10 is configured to include a CPU as a computer and a memory serving as a storage medium storing a computer program, and the like. The signal processing unit 9 and the control unit 10 include electrical circuits to perform various functions mentioned in the above.

The control unit 10 calculates the displacement amount of the measurement target 2 based on the image data according to the computer program, outputs the length measurement value (displacement amount) to an external device, and controls the operation of each part of the entire length-measuring instrument as the measurement apparatus 1.

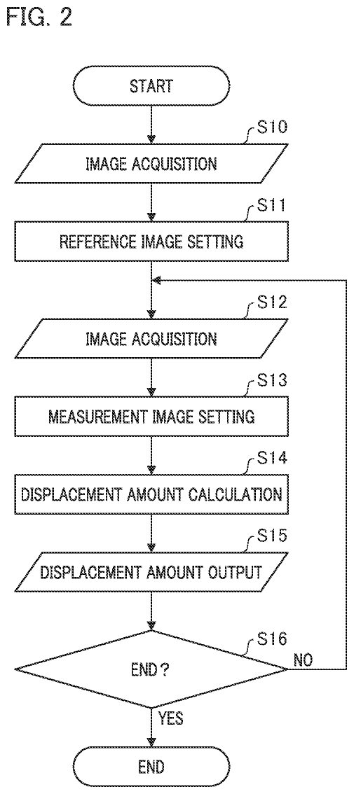

FIG. 2 is a flowchart showing an example of a measurement flow of a length-measuring instrument of a first embodiment, and the computer in the control unit 10 is configured to perform the operation of each step of the flowchart of FIG. 2 by executing a computer program stored in the memory.

Together with the start of a measurement, in step S10, the measurement apparatus 1 sequentially acquires images at a set sampling rate by the sensor 6. In step S11, the image first obtained is set as a reference image, and in step S12, an image is sequentially acquired, and in step S13, the image obtained in step S12 is set as a measurement image.

Then, in step S14, the displacement amount is calculated by computing the correlation between the reference image and the measurement image, and in step S15, the displacement amount is output as a length measurement value (displacement amount). In step S16, based on an operation output from an operation unit (not shown) or the like, it is determined as to whether or not to terminate the measurement operation, and in a case in which it is not terminated, the processing returns to step S12, and step S12 to S16 are repeated. When it is determined in step S16 that the processing ends, the measurement flow of FIG. 2 is terminated.

Note that in a case in which the sampling proceeds and the reference image deviates from the measurement region, processing such as updating the reference image may be performed. In this manner, in the measurement apparatus 1 of the first embodiment, light from the measurement target is received by an image capturing element, and a measurement value with respect to the measurement target is calculated by using the cross-correlation function of the two images that were acquired by the image capturing element, for example, as a measurement length value (displacement amount).

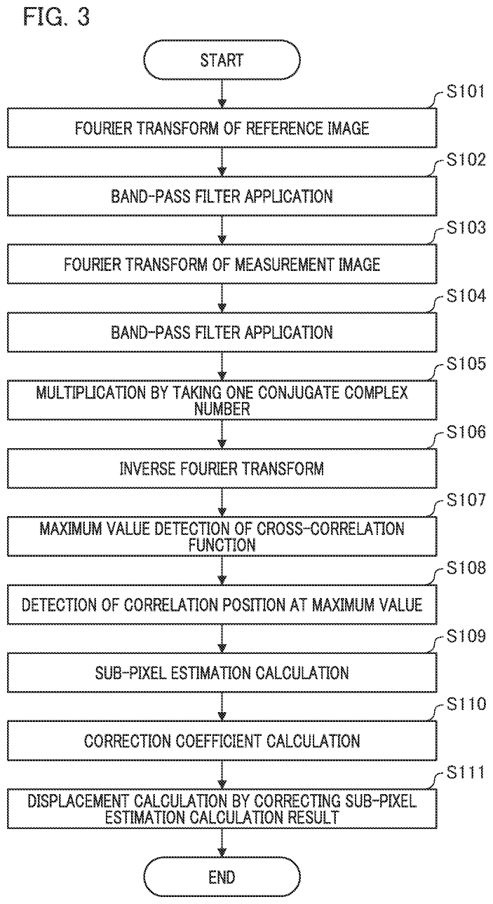

FIG. 3 is a flowchart showing a specific example of a displacement amount computation in step S14 of FIG. 2, and the computer in the control unit 10 is configured to execute the computer program stored in the memory, thereby performing the operation of each step of the flowchart of FIG. 3.

The displacement amount computation calculates the cross-correlation function between the reference image and the measurement image, and determines the displacement from the position of an extreme value. Further, the calculation of the cross-correlation function is performed, for example, in a frequency space. That is, the reference image is Fourier transformed in step S101, and in step S102, is limited to a predetermined frequency band by a band-pass filter.

Next, in step S103, the measurement image is Fourier transformed, and is limited to the same frequency band as in step S102 by a band-pass filter in step S104. Note that a window function may be applied when the Fourier transform is performed. Further, the bandpass filter in step S102 and S103 is configured to be capable of setting transmission/non-transmission for each frequency component with respect to the Fourier transformed data.

Next, in step S105, the Fourier transformed image is multiplied by taking one of the conjugate complex numbers, and in step S106, an inverse Fourier transform is performed to obtain a correlation function. In step S107, the maximum value (extreme value) of the cross-correlation function is detected, and the correlation position at the maximum value (extreme value) is detected in step S108. Note that the maximum value (extreme value) is determined on a pixel-by-pixel basis.

Furthermore, in step S109, a sub-pixel estimation computation is performed in order to calculate with a resolution equal to or smaller than the size corresponding to one pixel and to improve the accuracy. In the first embodiment, at the time of the sub-pixel estimation computation, the extreme value of the cross-correlation function and the values before and after thereof are used to approximate the function by using, for example, a quadratic function, and the extreme value of the approximate function is calculated as the sub-pixel estimation value.

In addition to a quadratic function, an approximation method such as a method of approximating as the intersection of a straight line, a method of approximating by a Gaussian distribution or the like may also be used. In this manner, the measurement value (displacement amount) is calculated based on the sub-pixel estimation value that is calculated based on the cross-correlation function.

Further, in the first embodiment, in step S110, a correction coefficient is calculated based on the spread of the peak of the cross-correlation function. Note that, because the spread of the peak shape of the cross-correlation function changes according to the configuration of the spatial frequency component, in the first embodiment, a correction coefficient is acquired based on the spread of the peak of the cross-correlation function. That is, in step S110, it can be said that the correction coefficient is calculated in accordance with the composition of the spatial frequency component.

In addition, in step S111, the measurement value (length measurement value) that is the result of the sub-pixel estimation computation is corrected by using the above-described correction coefficient to calculate a displacement amount of the measurement target 2. In this context, step S111 functions as a correction step to correct the measurement value. Note that, in a case in which the spread of the peak shape is equal to or greater than a predetermined value, the above-described measurement value is corrected, and in a case in which the spread of the peak shape is smaller than the above-described predetermined value, the error is not corrected by assuming that the error is negligible.

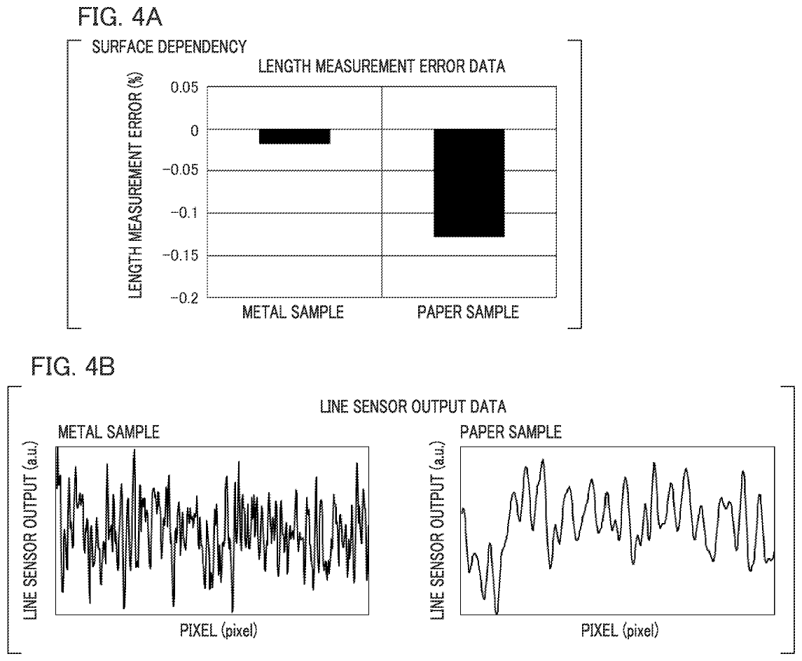

The above-described correction coefficient will be explained with reference to FIG. 4 to FIG. 6. FIG. 4 to FIG. 6 show examples of measurement errors under various conditions and line sensor output data obtained at the time of measurement. FIG. 4A is a diagram showing a surface dependency of length measurement error data in a case in which a metal sample and a paper sample are measured as a measurement target 2. FIG. 4B is a diagram showing line sensor output data of a metal sample and a paper sample.

In FIGS. 4A and 4B, the measurement conditions, including the optical system and signal processing, were made to be the same conditions. Note that FIG. 4A shows length measurement error data based on the sub-pixel estimation computation in a case in which the correction in step S111 is not performed. Whereas the length measurement error of the metal sample is about −0.02%, in the paper sample, a large length measurement error of about −0.12% occurs.

In addition, as shown in FIG. 4B, the line sensor output data of the metal sample has more high-frequency components compared to the line sensor output data of the paper sample. As shown in FIGS. 4A and 4B, it can be seen that when the surface of the measurement target 2 is rough and the low-frequency component is increased, the length measurement (displacement amount) error data increases.

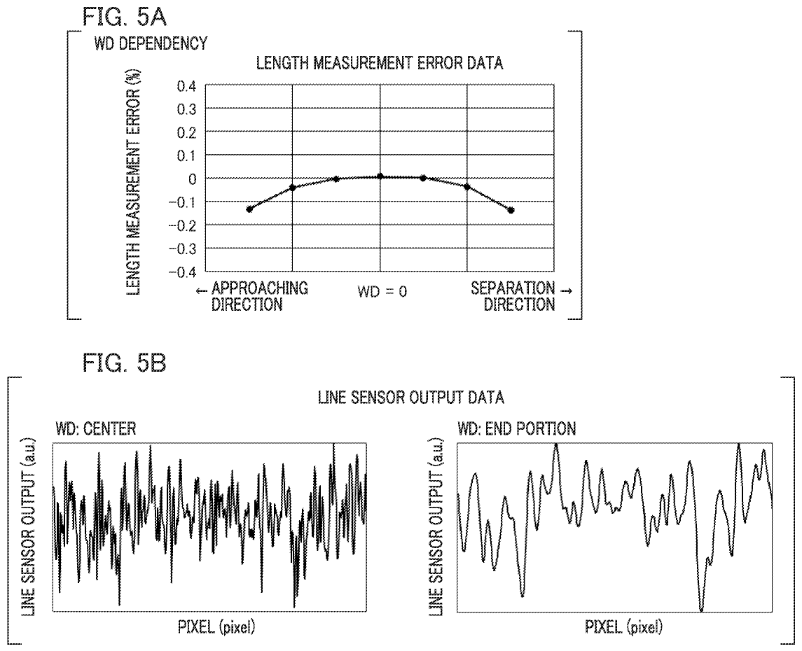

Next, FIG. 5A is a diagram showing the WD dependency of the length measurement error data in a case in which a metal sample is measured as the measurement target 2. FIG. 5B is a diagram showing line sensor output data in a case in which the WD is the center and in a case in which the WD is an end portion.

FIG. 5A shows the length measurement (displacement amount) error of a metal sample in a case in which the WD is different, where WD=0 [mm] on the horizontal axis represents the design value, and plots the length measurement error when the WD is changed. In FIGS. 5A and 5B, the same metal sample is used as the measurement target 2, and except for the WD, the same measurement conditions are set.

FIG. 5A shows the length measurement error data based on the sub-pixel estimation computation in a case in which the correction in step S111 is not performed. Further, as shown in FIG. 5B, the line sensor output data in a case in which the WD is the center has more high-frequency components than the line sensor output data in a case in which the WD is an end portion.

In a case in which a double-sided telecentric optical system is adopted, the change in optical magnification is small even when the WD is changed. However, as shown in FIG. 5A, the length measurement error data deteriorates in accordance with the fluctuation of the WD, and an error of about −0.1% occurs.

This error is larger in comparison to an error that is dependent on a change of the optical magnification, and indicates that it is an error factor other than that of the change of the optical magnification. That is, as shown in FIGS. 5A and 5B, it can be understood that as the WD of the measurement target 2 becomes large and the low-frequency component increases, the length measurement (displacement amount) error data increases.

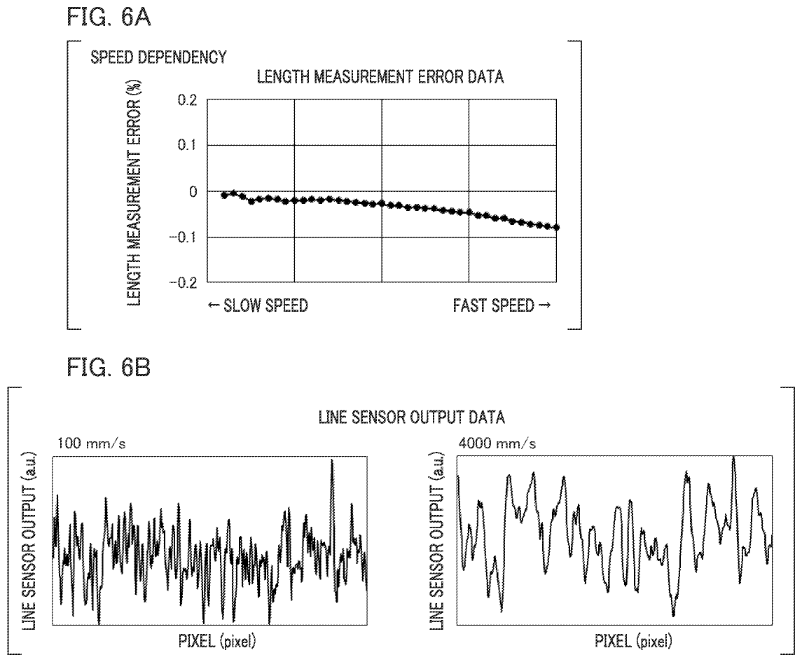

Next, FIG. 6A is a diagram showing the speed dependency of the length measurement error data of the measurement target 2. FIG. 6B is a diagram showing line sensor output data in a case in which the speed of the measurement target 2 is different. In FIGS. 6A and 6B, the same measurement conditions are set except for speed. Note that FIG. 6A shows length measurement (displacement amount) error data based on the sub-pixel estimation computation in a case in which the correction in step S111 is not performed.

As shown in FIG. 6A, when the speed becomes high, the error becomes large, and an error of about −0.1% occurs. There may be such a tendency due to a distortion of the optical system, in general, if a telecentric lens is adopted, distortion can be suppressed so as to be small.

The error that was generated in the present case is larger in comparison to an error that is dependent on distortion, and indicates that a speed that is not caused by the optical system is an error factor. That is, as shown in FIGS. 6A and 6B, it can be understood that when the speed of the measurement target 2 becomes faster and the low-frequency component increases, the length measurement (displacement amount) error data increases.

As shown above in FIG. 4 to FIG. 6, in a state in which no correction is performed in step s111, an error factor that does not depend on the characteristics of the optical system exists. Looking at the line sensor output data in FIG. 4 to FIG. 6, in a case in which the low-frequency component is dominant in the spatial frequency component that is included in the line sensor output, there is a tendency for errors to increase.

In the case shown in FIG. 4, when the line sensor outputs of the metal sample and the paper sample are compared, the difference in the surface characteristics represented by the surface roughness and the like of each is reflected, and there is a large difference in the configuration of the spatial frequency components that are included in the line sensor output. That is, the line sensor output of the paper sample having a large measurement error is dominant in the low-frequency component as compared to the line sensor output of the metal sample.

Similarly, in the case shown in FIG. 5, blurring occurs due to defocus that accompanies a change in the WD, and in the case shown in FIG. 6, shaking occurs due to the speed becoming high. It can be understood that the measurement error increases when the low-frequency component becomes dominant as the configuration of the spatial frequency component that is included in the line sensor output due to the influence of these blurring and shaking.

Such a tendency occurs because, in a case in which the low-frequency component becomes dominant as the configuration of the spatial frequency component that is included in the line sensor output that is used in the measurement, the peak spread of the cross-correlation function becomes large, and thus, the influence of a case in which a sub-pixel estimation error occurs becomes large.

Hereinafter, a relationship between the occurrence of a sub-pixel estimation error and the sub-pixel estimation error amount generated due to the spread of the peak shape of the cross-correlation function will be explained.

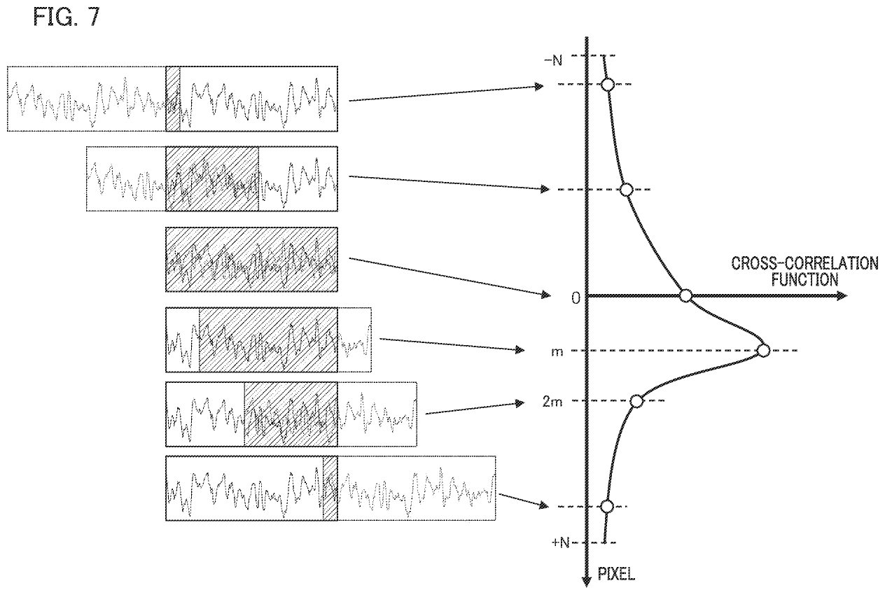

FIG. 7 is a schematic diagram for explaining the occurrence of a sub-pixel estimation error. In a case in which the computation of the cross-correlation function of two line sensor outputs that were acquired at different timings is performed in a real space, a calculation is made by multiplying each of the outputs while shifting one of the outputs by one pixel at a time, and then taking the sum.

In FIG. 7, the overlap state of the two line sensor outputs in a representative shift amount, and the value of the corresponding cross-correlation function are shown as graphs, the number of pixels of the line sensor is set to be N pixels, and the shift amount is set to be from −N to +N pixels.

In addition, the overlap region of the two line sensor output data is shown by oblique lines. In this example, an example of a case in which the displacement of m pixels (wherein m is a non-zero integer) is measured is shown.

In a case in which the displacement amount corresponds to an integer pixel, ideally, it is desirable that the peak of the cross-correlation function takes a symmetrical shape. However, as shown in FIG. 7, because asymmetry occurs in the overlap portion of the two line sensor outputs, the peak shape of the cross-correlation function being asymmetric also occurs. The occurrence of asymmetry can be considered as follows.

That is, in the computation of the cross-correlation function in real space, because the values of the two line sensor outputs exist in the overlap portion, the multiplication is executed as is. However, because there is no partner to be multiplied except in the overlap portion, they do not contribute to the computation of the cross-correlation function. In the 0th pixel of the cross-correlation function, the N pixels, which are all of the pixels related to the two line sensor outputs, become an overlap portion.

In the case of the mth pixel, the (N−m) pixel, and the (N−2m) pixel in the 2mth pixel, becomes the overlap portion. In the mth pixel, because the values of the two line sensor outputs in the overlap portion correspond to each other, the value of the cross-correlation function becomes a very large value. Because even in the overlap portion the values of the other cross-correlation functions do not correspond to the values of the two line sensor outputs, a random small value is taken as compared to the value of the cross-correlation function of the mth pixel.

Here, when the 0th pixel and the 2mth pixel of the cross-correlation function are compared, a difference of 2m pixels occurs in the overlap portion, as was described above. Because a difference occurs in the range that contributes to the computation of the cross-correlation function, in general, the value of the cross-correlation function of the 0th pixel becomes larger than the value of the cross-correlation function of the 2mth pixel.

In this manner, in the computation of the cross-correlation function, an asymmetry of the peak shape occurs. Then, the asymmetry of the peak shape of the cross-correlation function affects the sub-pixel estimation.

The fitting function that is used in subpixel estimation is generally a symmetric function, such as a quadratic function or a linear function. That is, by performing a fitting with a linear or quadratic function based on the cross-correlation function, the above-described sub-pixel estimation value is calculated.

However, as shown in FIG. 7, when fitting is performed in a state in which asymmetry has occurred, the estimated position of the peak becomes the (m−Δ) pixel. (Δ>0) means that the measured displacement has an error in the short direction. In a case in which m is a negative integer, it means that the motion is in the opposite direction, but becomes a similar result.

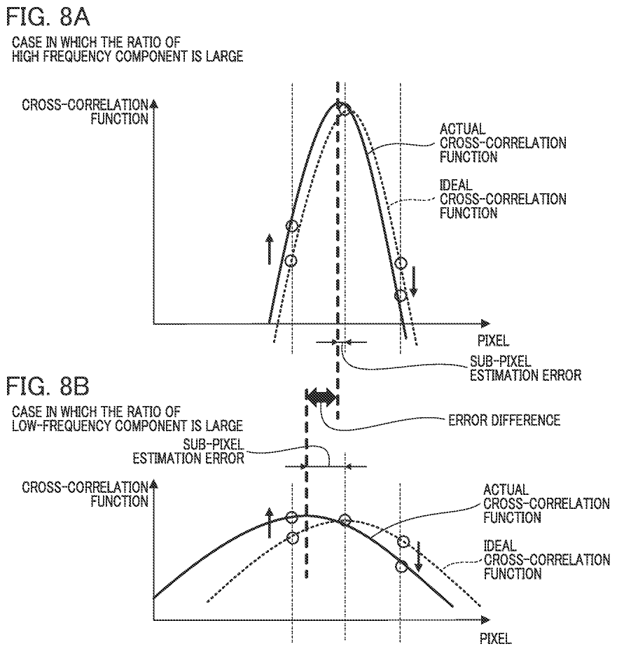

FIGS. 8A and 8B are schematic diagrams for explaining a relationship between a configuration of a spatial frequency component included in a line sensor output and a sub-pixel estimation error.

FIG. 8A is a diagram showing a cross-correlation function in a case in which the proportion of a high frequency component in the entire spatial frequency component included in the line sensor output is large, and is a diagram showing a case in which the ratio of a low frequency component to the entire spatial frequency component is large. FIG. 8B is a diagram showing a cross-correlation function in a case in which a low-frequency component is dominant as a configuration of a spatial frequency component included in a line sensor output.

In FIG. 8A, because the proportion of the high-frequency component is relatively large as compared to the case of FIG. 8B, the spread of the peak shape of the cross-correlation function becomes narrow, and in a case in which the ideal cross-correlation function is asymmetric, the magnitude of the subpixel estimation error is also small.

In contrast, as shown in FIG. 8B, in a case in which the ratio of the low-frequency component is greater than that in FIG. 8A, the spread of the peak shape of the cross-correlation function becomes large, and in a case in which the ideal cross-correlation function is asymmetric, the magnitude of the sub-pixel estimation error becomes large.

As described above, in a measurement method such as length measurement that uses a cross-correlation function, asymmetry occurs in the peak shape of the cross-correlation function. When the low-frequency component increases as the configuration of the spatial frequency component included in the sensor output, the spread of the peak shape of the cross-correlation function becomes large.

As the spread of the peak shape of the cross-correlation function becomes large, the influence of the asymmetry of the peak shape becomes large, and the sub-pixel estimation error, that is, the measurement error of the length measurement and the like, becomes large. In addition, the error occurs in a direction in which a measurement amount, such as a length measurement, is shortened.

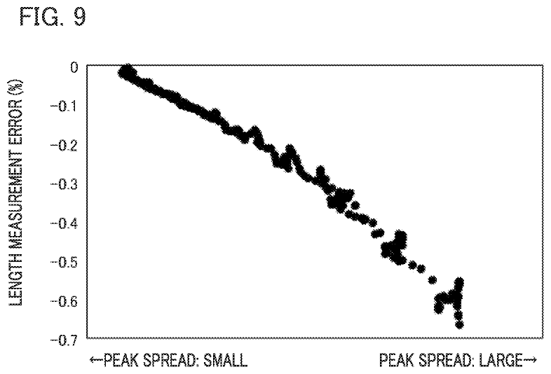

FIG. 9 is a graph that plots the relationship between the spread of the peak shape of the cross-correlation function and the length measurement error based on the result of performing a length measurement under various measurement conditions. As shown in FIG. 9, a correlation between the spread of the peak shape of the cross-correlation function and the length measurement error can be obtained.

When the ratio of the low-frequency component in the spatial frequency components of the two images, which are sensor outputs, increases, the peak shape of the cross-correlation function has a spreading relationship. Thus, the spread of the peak, which is the horizontal axis of FIG. 9, can be replaced by an increase in the ratio of the low-frequency component, which is the configuration of the spatial frequency component.

In the first embodiment, correction of the length measurement error was performed by using the relationship shown in the graph of FIG. 9. That is, in order to calculate the correction coefficient in step S110 of FIG. 3, the spread of the peak shape of the cross-correlation function that was acquired during the length measurement calculation is calculated. Then, based on the relationship between the spread of the peak shape and the length measurement error in FIG. 9, the length measurement error is estimated and a correction coefficient is determined.

At this time, the correction coefficient can be acquired by referring to an approximate expression such as a polynomial equation in which the length measurement (displacement amount) error and the spread of the peak shape of the cross-correlation function are made variables, or to a table stored in advance in the memory.

In a case in which the spread of the peak shape of the cross-correlation function is calculated by using an approximate expression, the computation can be performed by utilizing the quadratic function fitting that is used in the sub-pixel estimation computation of step S109.

Note that, in the graph of FIG. 9, the relationship between the peak spread and the length measurement (displacement amount) error is shown, and although this relationship may be used as an approximate expression or a table to calculate and correct a correction coefficient, for example, the relationship between the peak spread and the correction coefficient of the length measurement error may be used as an approximate expression or a table. In this case, the correction factor for the length measurement error corresponds to the reciprocal that changed the polarity of the length measurement error or the like.

Further, in that case, by using the ratio of the low frequency component instead of the peak spread, the relationship between the ratio of the low-frequency component and the correction coefficient may be made as an approximate expression or a table, and a correction made thereby.

Note that, as can be understood from FIG. 9, in a case in which the peak spread is equal to or less than a predetermined peak spread value, that is, in a case in which the ratio of a low-frequency component is less than a predetermined ratio, because the length measurement error can be ignored, in such a case the correction coefficient of the length measurement error may be set to zero, and no correction performed.

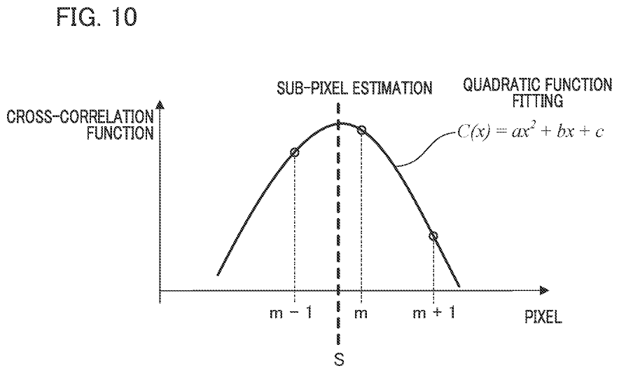

FIG. 10 is a schematic diagram for explaining a quadratic function fitting that is used in a sub-pixel estimation computation. The sub-pixel estimation computation is executed by using the pixel values before and after the maximum value of the cross-correlation function as the center of the peak. Here, an example of a case in which the maximum value is obtained at the mth pixel is shown. A quadratic function that is used for fitting is, for example, Equation (1).

C(x)=a·x²+b·x±c (1)

The three unknowns of the function of this Equation (1) are determined by using the maximum value of the cross-correlation function and the total of three sets of data before and after the maximum value. When the position of the pixel to be the maximum value is mth, the value of the maximum value is C(m), and similarly the m±1th pixel before and after the maximum value is C(m±1), the determination can be made by using the following equations (2) to (4).

$$a = \frac{C ( m + 1 ) - 2 \cdot C ( m ) + C ( m - 1 )}{2} \qquad ( 2 )$$

$$b = - 2 \cdot a \cdot m + \frac{C ( m + 1 ) - C ( m - 1 )}{2} \qquad ( 3 )$$

$$c = C ( m ) - a \cdot {m}^{2} - b \cdot m \qquad ( 4 )$$

Note that the sub-pixel estimation position can be determined, for example, by using Equation (5) and Equation (6) as points at which the derivative of the function to be fitted becomes zero. That is, when the sub-pixel estimation position is set to be S, this becomes the following:

$${C}^{′} ( S ) = 2 \cdot a \cdot S + b = 0 \qquad ( 5 )$$

$$S = - \frac{b}{2 \cdot a} \qquad ( 6 )$$

The sub-pixel estimation position can be determined from the above-described a and b. In this context, the spread of the peak shape of the cross-correlation function can be made the width of the intersection of the fitted quadratic function with, for example, the x-axis. By using the solution formula of the quadratic equation, the spread of the peak shape of the cross-correlation function can be calculated by using Equation (7).

$$\frac{- b + \sqrt{{b}^{2} - 4 \cdot a \cdot c}}{2 \cdot a} - \frac{- b - \sqrt{{b}^{2} - 4 \cdot a \cdot c}}{2 \cdot a} = \frac{\sqrt{{b}^{2} - 4 \cdot a \cdot c}}{a} \qquad ( 7 )$$

Note that, in order to omit the calculation of the square root, the spread of the peak shape of the cross-correlation function may be calculated by using the squared value. Further, instead of setting the spread of the peak shape of the cross-correlation function as the width of the intersection with the x-axis of the fitted quadratic function, the spread can be a width (for example, a half-width) of a waveform at a predetermined ratio of the threshold value with respect to the peak value. That is, the spread of the peak shape may be calculated based on the maximum value of the cross-correlation function, the position of the maximum value, and the values of the positions before and after thereof.

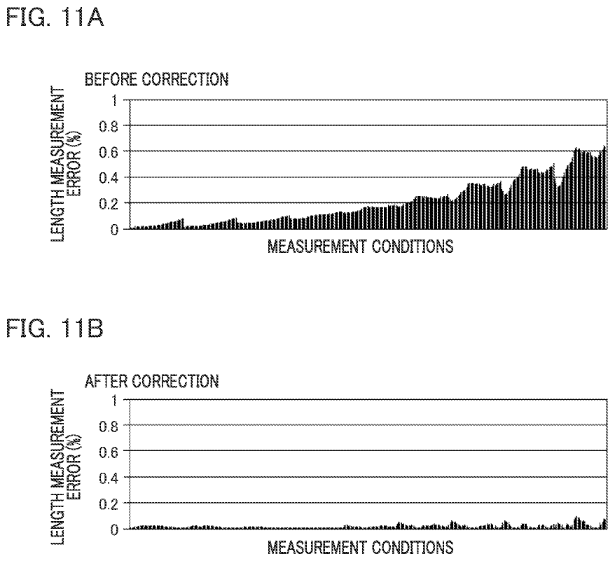

FIG. 11A is a diagram showing a length measurement error in a case in which no correction was performed under various conditions. In this context, the error is shown as an absolute value. As shown in the figure, a large error of about 0.6% occurs under certain conditions.

FIG. 11B is a diagram showing a length measurement error in a case in which the correction is performed under the same condition. In this context as well, an error is displayed as an absolute value. In FIG. 11B, the length measurement error is 0.1% or less under any condition. In this manner, by executing the correction step of step S111 in the first embodiment, the length measurement error is greatly improved.

In this manner, it is possible to correct the length measurement value (displacement amount) by diverting the information that is obtained from the sensor output. Note that, in the first embodiment, although a method of estimating the length measurement error from the spread of the peak shape of the cross-correlation function was shown, the configuration of the spatial frequency component that is included in the line sensor output can also be calculated by calculating the power spectrum based on the Fourier-transformed data.

In addition, as a method of calculating the configuration of the spatial frequency component that is included in the line sensor output, it is also possible to determine that the high frequency component is large if the number of cross points with respect to the threshold value is large. Further, for example, the ratio of the high-frequency component can be determined by using differential data. Conversely, the low-frequency component ratio may be determined by using a low-pass filter.

Note that the low-frequency component in the first embodiment may be a frequency component that is equal to or less than a predetermined frequency threshold such as an average frequency, for example, of the configuration (frequency spectrum distribution) of the spatial frequency component that is included in the line sensor output.

Alternatively, for example, it is sufficient that the deviation value on the low frequency side in the configuration of the spatial frequency component (frequency spectral distribution) is equal to or less than a predetermined threshold value. In addition, in the first embodiment, the ratio of the low-frequency component refers to, for example, occurrences of a frequency component that is lower than the average frequency in the configuration of the spatial frequency component (the histogram of the frequency spectrum) that occupies all occurrences.

### Second Embodiment

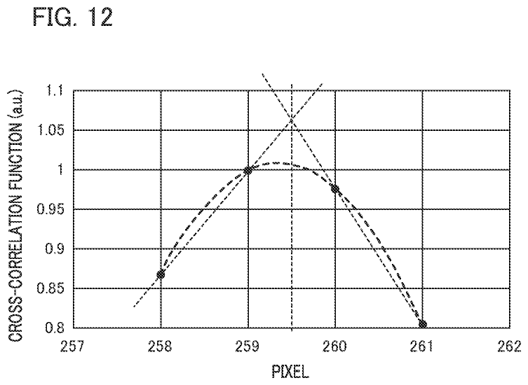

Next, a second embodiment of the measurement apparatus of the present invention will be explained. FIG. 12 is a diagram explaining an example of using a linear function fitting as a method of calculating the sub-pixel estimation of the cross-correlation function and the spread of the peak shape.

The linear function fitting is performed by combining the maximum value of the cross-correlation function with the position thereof, and the value of the third magnitude and the position thereof. In addition, the linear function fitting is also performed by combining the values of the second and fourth magnitudes and the positions thereof. Then, a sub-pixel estimation can be performed by calculating the intersection point of the two linear function fitting results.

In addition, it becomes possible to calculate the spread of the peak shape of the cross-correlation function from the gradient of the slope of the two linear function fitting results. Then, the length measurement error is acquired in step S110 based on the spread of the peak shape of the cross-correlation function that was computed in this manner and, for example, the data of the memory that stored the graph of FIG. 9 as a function table. Then, in step S111, it is possible to correct the result of the sub-pixel estimation computation result by using the length measurement error.

Note that, in the first embodiment and the second embodiment, a measurement apparatus 1 has been explained by using an example of a length-measuring instrument. However, the measurement apparatus 1 may be, for example, a distance measurement apparatus configured to measure a distance to a measurement target or a distance distribution based on a correlation function of two images. Alternatively, it may be, for example, a measurement apparatus configured to measure the shape, position and posture of a measurement target.

In addition, in the above embodiments, as explained with reference to FIG. 9, the correction coefficient and the like were acquired by an approximate expression or a table based on the peak spread and the ratio of the low-frequency component. However, for example, based on the correlation shown in FIG. 4, control can be performed so as to increase the correction coefficient the larger the surface roughness of the measurement target.

Further, in addition to calculating the measurement value based on the sub-pixel estimation that was calculated based on the cross-correlation function, the above-described measurement value may be corrected in a case in which the surface roughness of the measurement target is equal to or greater than a predetermined roughness.

Alternatively, control may be carried out in which, based on the correlation that is shown in FIG. 5, the larger the error in the distance WD between a predetermined reference surface of the measurement apparatus and the measurement target, the larger the correction coefficient. Further, a measurement value may be calculated based on the sub-pixel estimation that is calculated based on the cross-correlation function, and the above-described measurement value may be corrected in a case in which the error of the distance WD is equal to or greater than a predetermined error.

Alternatively, based on the correlation that is shown in FIG. 6, the larger the speed of the measurement target, the correction coefficient may be controlled to be made larger. Further, in addition to calculating the measurement value based on the sub-pixel estimation that is calculated based on the cross-correlation function, the above-described measurement value may be corrected in a case in which the speed of the measurement target is equal to or greater than a predetermined speed.

### Third Embodiment

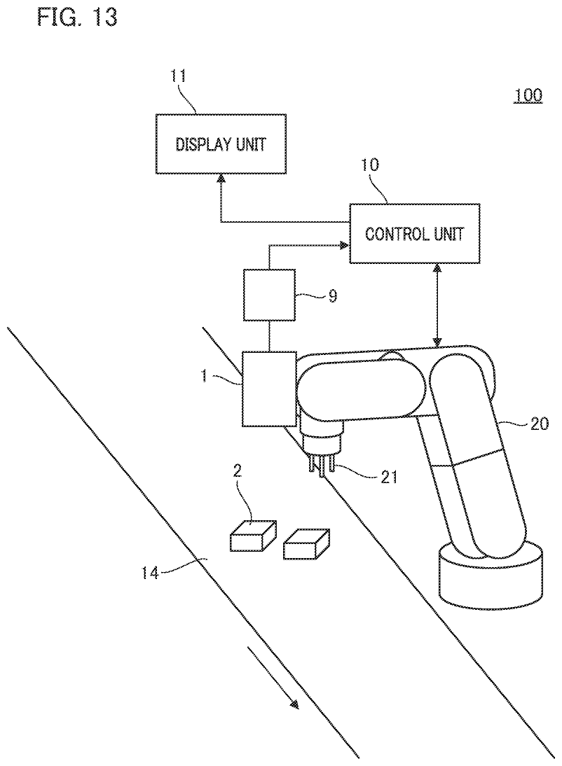

FIG. 13 is a diagram showing a control system configured to include a measurement apparatus and a robot arm in a third embodiment, wherein a control system 100 is configured by the measurement apparatus 1, the signal processing unit 9, the control unit 10, a display unit 11, a conveying unit 14, and a robot arm 20 and the like of the first embodiment and the second embodiment.

In addition, the measurement apparatus 1 is used by being supported by a robot arm 20 serving as a support apparatus. The light flux that is emitted from the light source 3 housed in the measurement apparatus 1 is condensed by the light condensing member 4 on the measurement target 2, and illuminates the measurement target 2, which is conveyed in the arrow direction by the conveying unit 14.

The sensor of the measurement apparatus 1 captures an image of the measurement target 2, which is illuminated by the light source 3 and conveyed by the conveying unit 14, acquires image capturing data, and inputs the image data to the control unit 10 via the signal processing unit 9. Then, the control unit 10 executes a measurement step of measuring the length measurement, the shape, the position, the posture distance, and the like of the measurement target 2 based on the image data, and calculates a measurement value.

Based on the measurement values obtained by the measurement step, such as length, shape, position and posture, and distance, the control unit 10 sends a drive command to the robot arm 20 so as to control the movement of the robot arm 20. In addition, the measurement data that is measured by the measurement apparatus 1 and the obtained image may be displayed on the display unit 11.

The robot arm 20 holds (grips) the measurement target 2 by a robot hand (gripping unit) 21 at the distal end based on the measurement value that was obtained by the measurement apparatus 1, and performs movement and posture control processing, such as translation and rotation.

Further, by performing a process such as assembling the measurement target 2 on another component by the robot arm 20, an article that is configured by a plurality of components, for example, an electronic circuit board or a machine, is manufactured. In addition, by further performing other processing treatment steps with respect to the measurement target 2 that has been moved, a process of manufacturing a final article can also be performed. Note that a control unit for controlling the robot arm 20 may be provided separately from the control unit 10.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions. In addition, as a part or the whole of the control according to the embodiments, a computer program realizing the function of the embodiments described above may be supplied to the measurement apparatus through a network or various storage media. Then, a computer (or a CPU, an MPU, or the like) of the measurement apparatus may be configured to read and execute the program. In such a case, the program and the storage medium storing the program configure the present invention.

This application claims the benefit of Japanese Patent Application No. 2021-208219 filed on Dec. 22, 2021, which is hereby incorporated by reference herein in its entirety.

What is claimed is:

1. A measurement apparatus comprising a circuit configured to function as:
a measurement unit configured to calculate a measurement value with respect to a measurement target by using a cross-correlation function of two images of the measurement target acquired by an image capturing element, and
a correction unit configured to correct the measurement value according to a configuration of a spatial frequency component of the two images.

2. The measurement apparatus according to claim 1, wherein the measurement value is calculated based on a sub-pixel estimation value calculated based on the cross-correlation function.

3. The measurement apparatus according to claim 2, wherein the sub-pixel estimation value is calculated by performing a fitting by a linear function or a quadratic function based on the cross-correlation function.

4. The measurement apparatus according to claim 1, wherein the spread of the peak shape of the cross-correlation function changes according to the configuration of the spatial frequency component, and in a case in which the spread of the peak shape is equal to or greater than a predetermined value, the correction unit corrects the measurement value.

5. The measurement apparatus according to claim 4, wherein the correction unit is configured to calculate the spread of the peak shape based on the maximum value of the cross-correlation function, the position of the maximum value, and the values of the positions before and after thereof.

6. The measurement apparatus according to claim 4, wherein the correction unit is configured to perform a correction by an approximate expression or a table based on a relationship between the spread of the peak shape and the measurement error.

7. The measurement apparatus according to claim 1, wherein the correction unit is further configured to correct the measurement value in a case in which the ratio of a frequency component lower than a predetermined frequency in a distribution of the spatial frequency component is equal to or greater than a predetermined ratio.

8. A measurement apparatus comprising a circuit configured to function as:
a measurement unit configured to calculate a measurement value with respect to a measurement target by using a cross-correlation function of two images of the measurement target acquired by an image capturing element, and
a correction unit configured to correct the measurement value according to the surface roughness of the measurement target.

9. The measurement apparatus according to claim 8, wherein the measurement value is calculated based on a sub-pixel estimation value calculated based on the cross-correlation function, and the correction unit is configured to correct the measurement value in a case in which the surface roughness of the measurement target is equal to or greater than a predetermined roughness.

10. A measurement apparatus comprising a circuit configured to function as:
a measurement unit configured to calculate a measurement value with respect to a measurement target by using a cross-correlation function of two images of the measurement target acquired by an image capturing element, and
a correction unit configured to correct the measurement value according to an error in a distance between a predetermined reference surface of the measurement apparatus and the measurement target.

11. The measurement apparatus according to claim 10, wherein the measurement value is calculated based on a sub-pixel estimation value calculated based on the cross-correlation function, and the correction unit is configured to correct the measurement value in a case in which the error of the distance is greater than or equal to a predetermined error.

12. A measurement apparatus comprising a circuit configured to function as:
a measurement unit configured to calculate a measurement value with respect to a measurement target by using a cross-correlation function of two images of the measurement target acquired by an image capturing element, and
a correction unit configured to correct the measurement value according to the speed of the measurement target.

13. The measurement apparatus according to claim 12, wherein the measurement value is calculated based on a sub-pixel estimation value calculated based on the cross-correlation function, and the correction unit is configured to correct the measurement value in a case in which the speed of the measurement target is equal to or greater than a predetermined speed.

14. A non-transitory computer-readable storage medium configured to store a computer program comprising instructions for executing the following steps:
calculating a measurement value with respect to a measurement target by using a cross-correlation function of the two images of the measurement target acquired by an image capturing element, and
correcting the measurement value according to a configuration of a spatial frequency component of the two images.

15. A system including:
a measurement unit configured to calculate a measurement value with respect to a measurement target by using a cross-correlation function of two images of the measurement target acquired by an image capturing element,
a correction unit configured to correct the measurement value according to a configuration of a spatial frequency component of the two images, and
a robot configured to hold and move the measurement target based on the measurement value.

16. A method of manufacturing an article that executes the following steps:
a light receiving step of receiving light from a measurement target by an image capturing element,
a measurement step of calculating a measurement value with respect to the measurement target by using a cross-correlation function of two images acquired by the image capturing element,
a correction step of correcting the measurement value according to the configuration of the spatial frequency component of the two images, and
a step of manufacturing an article by processing the measurement target based on the measurement value that has been corrected by the correction step.
